(19) United States
(12) Patent Application Publication
(10) Pub. No.: US 2003/0119960 A1
(43) Pub. Date: Jun. 26, 2003

(54) Rubber compositions and method for decreasing the tangent delta value

(76) Inventors: Sung W. Hong, Cheshire, CT (US); Martin J. Hannon, Bethany, CT (US); Peter K. Greene, Goshen, CT (US)

Correspondence Address: Michael E. Carmen, DILWORTH & BARRESE, LLP, 333 Earle Ovington Blvd., Uniondale, NY, 11553, US

(21) Appl. No.: 09/945,598

(22) Filed: Sep. 4, 2001

(51) Int. Cl. C08K 5/06; C08K 3/34

(52) U.S. Cl. 524/377; 524/565; 524/571; 524/574; 524/575; 524/493; 524/188; 523/212

(57) ABSTRACT

A rubber composition is disclosed wherein the rubber composition contains at least (a) a rubber component; (b) a silica filler; (c) a coupling agent; and (d) a cure-enhancing amount of at least one polyalkylene oxide having a weight average molecular weight less than 200. The compositions may also include suitable amounts of other ingredients such as carbon black, antiozonants, antioxidants, etc.

### BACKGROUND OF THE INVENTION

1. Technical Field

This invention relates generally to rubber compositions and a method for decreasing the tangent delta value (i.e., hysteresis) and improving the cure rate of the rubber compositions. The rubber compositions are particularly useful for tire tread applications in vehicles, e.g., passenger automobiles and trucks.

2. Description of the Related Art

The tire treads of modem tires must meet performance standards which require a broad range of desirable properties. Generally, three types of performance standards are important in tread compounds. They include good wear resistance, good traction and low rolling resistance. Major tire manufacturers have developed tire tread compounds which provide lower rolling resistance for improved fuel economy and better skid/traction for a safer ride. Thus, rubber compositions suitable for, e.g., tire treads, should exhibit not only desirable strength and elongation, particularly at high temperatures, but also good cracking resistance, good abrasion resistance, desirable skid resistance and low tangent delta values at low frequencies for desirable rolling resistance of the resulting treads. Additionally, a high complex dynamic modulus is necessary for maneuverability and steering control.

Presently, silica has been added to rubber compositions as a filler to replace some or substantially all of the carbon black filler to improve these properties, e.g., lower rolling resistance. Although more costly than carbon black, the advantages of silica include, for example, improved wet traction, low rolling resistance, etc., with reduced fuel consumption. Indeed, as compared to carbon black, there tends to be a lack of, or at least an insufficient degree of, physical and/or chemical bonding between the silica particles and the rubber to enable the silica to become a reinforcing filler for the rubber thereby giving less strength to the rubber. Therefore a silica filler system requires the use of coupling agents.

Coupling agents are typically used to enhance the rubber reinforcement characteristics of silica by reacting with both the silica surface and the rubber elastomer molecule. Such coupling agents, for example, may be premixed or pre-reacted with the silica particles or added to the rubber mix during the rubber/silica processing, or mixing, stage. If the coupling agent and silica are added separately to the rubber mix during the rubber/silica processing, or mixing, stage, it is considered that the coupling agent then combines in situ with the silica.

A coupling agent is a bi-functional molecule that will react with the silica at one end thereof and cross-link with the rubber at the other end. In this manner, the reinforcement and strength of the rubber, e.g., the toughness, strength, modulus, tensile and abrasion resistance, are particularly improved. The coupling agent is believed to cover the surface of the silica particle which then hinders the silica from agglomerating with other silica particles. By interfering with the agglomeration process, the dispersion is improved and therefore the wear and fuel consumption are improved.

The use of silica in relatively large proportions for improving various tire properties requires the presence of a sufficient amount of a coupling agent. Coupling agents and silica however retards the cure. Therefore, a silica/coupling agent tread formulation has been found to undesirably slow the cure rate of the rubber. Additionally, by employing high amounts of the coupling agents result in the rubber compositions being more costly to manufacture since these materials are expensive.

### SUMMARY OF THE INVENTION

In accordance with the present invention a rubber composition is provided which comprises (a) a rubber component; (b) a silica filler; (c) a coupling agent; and (d) a cure-enhancing amount of a polyalkylene oxide having a weight average molecular weight of less than 200.

By employing a cure-enhancing amount of at least one polyalkylene oxide having a weight average molecular weight of less than 200 in forming the rubber compositions disclosed herein results in the rubber compositions advantageously possessing a higher cure rate. Additionally, the rubber compositions herein also possess a lower or substantially equivalent tangent delta value relative to a rubber composition employing only a coupling agent with a significant amount up to the entire amount of polyalkylene oxide not being present therein.

It has been discovered that by adding accelerators such as, for example, thiazoles, sulfenamides, thiurams, guanadines and dithiocarbamates, to the first mixing stage (i.e., masterbatch) and heating the mixture to a high temperature, e.g., a temperature that may reach 160° C., results in the accelerators being consumed for crosslinking and the Mooney Viscosity (at 100° C.) of the masterbatch increased to more than 100 such that the rubber compositions cannot be processable. Also, the use of the accelerators in the masterbatch did not improve the cure rate of the rubber compositions.

However, when the polyalklyene oxide is added to the masterbatch, the polyalklyene oxide is not consumed during high temperature mixing and instead increases the cure rate in silica containing tread compounds, which is unexpected. This favorable result, which also lowers or maintains the tangent delta value, is obtained using lower levels of coupling agent with a cure-enhancing amount of a polyalkylene oxide having a weight average molecular weight of less than 200, compared to the higher levels of coupling agent, alone. This enhanced cure rate and lower or equivalent tangent delta value may come from improved vulcanization and coupling of the silica to rubber, simultaneously.

Accordingly, the polyalkylene oxides herein have been found to increase the cure rate and, in some instances, to fully recapture any cure slow down presumed to have resulted from the use of the silica with higher amounts of a coupling agent relative to the present disclosure which employs lower amounts of a coupling agent with a cure-enhancing amount of a polyalkylene oxide. In this manner, the polyalkylene oxides have enabled achievement of the silica benefits in full without the prior art disadvantage. Additionally, by employing significantly lower amounts of the coupling agent in the rubber compositions described herein relative to the amounts of coupling agent used in rubber compositions formed with relatively little to no polyalkylene oxide, a greater economical advantage is achieved by using less materials of the more expensive coupling agent.

The term “phr” is used herein as its art-recognized sense, i.e., as referring to parts of a respective material per one hundred (100) parts by weight of rubber.

The expression “cure-enhancing amount” as applied to the polyalkylene oxide employed in the rubber compositions of this invention shall be understood to mean an amount when employed with the coupling agent provides a decreased cure time of the rubber composition.

### DESCRIPTION OF THE PREFERRED EMBODIMENTS

The rubber compositions of this invention contain at least (a) a rubber component; (b) a silica filler; (c) a coupling agent; and (d) a cure-enhancing amount of at least one polyalkylene oxide having a weight average molecular weight of less than 200.

The rubber components for use herein are based on highly unsaturated rubbers such as, for example, natural or synthetic rubbers. Representative of the highly unsaturated polymers that can be employed in the practice of this invention are diene rubbers. Such rubbers will ordinarily possess an iodine number of between about 20 to about 400, although highly unsaturated rubbers having a higher or a lower (e.g., of 50-100) iodine number can also be employed. Illustrative of the diene rubbers that can be utilized are polymers based on conjugated dienes such as, for example, 1,3-butadiene; 2-methyl-1,3-butadiene; 1,3-pentadiene; 2,3-dimethyl-1,3-butadiene; and the like, as well as copolymers of such conjugated dienes with monomers such as, for example, styrene, alpha-methylstyrene, acetylene, e.g., vinyl acetylene, acrylonitrile, methacrylonitrile, methyl acrylate, ethyl acrylate, methyl methacrylate, ethyl methacrylate, vinyl acetate, and the like. Preferred highly unsaturated rubbers include natural rubber, cis-polyisoprene, polybutadiene, poly(styrene-butadiene), styrene-isoprene copolymers, isoprene-butadiene copolymers, styrene-isoprene-butadiene tripolymers, polychloroprene, chloro-isobutene-isoprene, nitrile-chloroprene, styrene-chloroprene, and poly(acrylonitrile-butadiene). Moreover, mixtures of two or more highly unsaturated rubbers with elastomers having lesser unsaturation such as EPDM, EPR, butyl or halogenated butyl rubbers are also within the contemplation of the invention.

The silica may be of any type that is known to be useful in connection with the reinforcing of rubber compositions. Examples of suitable silica fillers include, but are not limited to, silica, precipitated silica, amorphous silica, vitreous silica, fumed silica, fused silica, synthetic silicates such as aluminum silicates, alkaline earth metal silicates such as magnesium silicate and calcium silicate, natural silicates such as kaolin and other naturally occurring silicas and the like. Also useful are highly dispersed silicas having, e.g., BET surfaces of from about 5 to about 1000 m²/g and preferably from about 20 to about 400 m²/g and primary particle diameters of from about 5 to about 500 nm and preferably from about 10 to about 400 nm. These highly dispersed silicas can be prepared by, for example, precipitation of solutions of silicates or by flame hydrolysis of silicon halides. The silicas can also be present in the form of mixed oxides with other metal oxides such as, for example, Al, Mg, Ca, Ba, Zn, Zr, Ti oxides and the like. Commercially available silica fillers known to one skilled in the art include, e.g., those available from such sources as Cabot Corporation under the Cab-O-Sil® tradename; PPG Industries under the Hi-Sil and Ceptane tradenames; Rhodia under the Zeosil tradename and Degussa AG under the Ultrasil and Coupsil tradenames. Mixtures of two or more silica fillers can be used in preparing the rubber composition of this invention. A preferred silica for use herein is Zeosil 1165MP manufactured by Rhodia.

The silica filler is incorporated into the rubber composition in amounts that can vary widely. Generally, the amount of silica filler can range from about 5 to about 150 phr, preferably from about 15 to about 100 phr and more preferably from about 30 to about 90 phr.

If desired, carbon black fillers can be employed with the silica filler in forming the rubber compositions of this invention. Suitable carbon black fillers include any of the commonly available, commercially-produced carbon blacks known to one skilled in the art. Generally, those having a surface area (EMSA) of at least 20 m²/g and more preferably at least 35 m²/g. up to 200 m²/g or higher are preferred. Surface area values used in this application are those determined by ASTM test D-3765 using the cetyltrimethyl-ammonium bromide (CTAB) technique. Among the useful carbon blacks are furnace black, channel blacks and lamp blacks. More specifically, examples of the carbon blacks include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon blacks which may be utilized include acetylene blacks. Mixtures of two or more of the above blacks can be used in preparing the rubber compositions of the invention. Typical values for surface areas of usable carbon blacks are summarized in the following Table I.

TABLE I
Carbon Blacks

| ASTM | Surface Area |
|---|---|
| Designation | (m²/g) |
| (D-1765-82a) | (D-3765) |
| N-110 | 126 |
| N-234 | 120 |
| N-220 | 111 |
| N-339 | 95 |
| N-330 | 83 |
| N-550 | 42 |
| N-660 | 35 |

The carbon blacks utilized in the invention may be in pelletized form or an unpelletized flocculant mass. Preferably, for ease of handling, pelletized carbon black is preferred. When employing carbon blacks in rubber compositions, it is particularly advantageous to use an amount of silica which exceeds the amount of carbon blacks on a volume-by-volume basis with the polyalkylene oxides, which are discussed herein below, to provide a rubber composition possessing both an improved cure rate and a lower tangent delta value, e.g., a volume ratio of silica to carbon black ranging from about 1.5:1 to about 5:1. In general, the volume ratio of silica to carbon black may be at least about 1:5, preferably at least about 1:1 and most preferably at least about 5:1. Accordingly, the carbon blacks, if any, are ordinarily incorporated into the rubber composition in amounts ranging from about 1 to about 80 phr and preferably from about 5 to about 50 phr.

In compounding a silica filled rubber composition of the present invention, it is advantageous to employ a coupling agent. Such coupling agents, for example, may be premixed, or pre-reacted, with the silica particles or added to the rubber mix during the rubber/silica processing, or mixing, stage. If the coupling agent and silica are added separately to the rubber mix during the rubber/silica mixing, or processing stage, it is considered that the coupling agent then combines in situ with the silica.

In particular, such coupling agents are generally composed of a silane which has a constituent component, or moiety, (the silane portion) capable of reacting with the silica surface and, also, a constituent component, or moiety, capable of reacting with the rubber, e.g., a sulfur vulcanizable rubber which contains carbon-to-carbon double bonds, or unsaturation. In this manner, then, the coupling agent acts as a connecting bridge between the silica and the rubber thereby enhancing the rubber reinforcement aspect of the silica.

The silane component of the coupling agent apparently forms a bond to the silica surface, possibly through hydrolysis, and the rubber reactive component of the coupling agent combines with the rubber itself. Generally, the rubber reactive component of the coupling agent is temperature sensitive and tends to combine with the rubber during the final and higher temperature sulfur vulcanization stage, i.e., subsequent to the rubber/silica/coupling agent mixing stage and after the silane group of the coupling agent has combined with the silica. However, partly because of typical temperature sensitivity of the coupling agent, some degree of combination, or bonding, may occur between the rubber-reactive component of the coupling agent and the rubber during an initial rubber/silica/coupling agent mixing stage and prior to a subsequent vulcanization stage.

Suitable rubber-reactive group components of the coupling agent include, but are not limited to, one or more of groups such as mercapto, amino, vinyl, epoxy, and sulfur groups. Preferably the rubber-reactive group components of the coupling agent is a sulfur or mercapto moiety with a sulfur group being most preferable.

Examples of a coupling agent for use herein are vinyltrichlorosilane, vinyltrimethoxysilane, vinyltriethoxysilane, vinyltris(β-methoxyethoxy)silane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, -β(aminoethyl)-γ-aminopropylmethyldimethoxysilane, N-β-(aminoethyl)γ-aminopropyltrimethoxysilane, N-β(aminoethyl)γ-aminopropyltriethoxysilane, γ-aminopropyltrimethoxysilane, γ-aminopropyltriethoxysilane, -phenyl-γ-aminopropyltrimethoxysilane, γ-chloropropyltrimethoxysilane, γ-mercaptopropyltrimethoxysilane and combinations thereof.

Representative examples of the preferred sulfur-containing coupling agents are sulfur-containing organosilicon compounds. Specific examples of suitable sulfur-containing organosilicon compounds are of the following general formula:

Z—R¹—Sₙ—R²—Z

in which Z is selected from the group consisting of

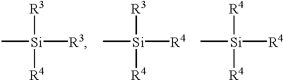

wherein R³ is an alkyl group of from 1 to 4 carbon atoms, cyclohexyl or phenyl; and R⁴ is an alkoxy of from 1 to 8 carbon atoms, or cycloalkoxy of 5 to 8 carbon atoms; and R¹ and R² are independently a divalent hydrocarbon of from 1 to 18 carbon atoms and n is an integer of from about 2 to about 8.

Specific examples of sulfur-containing organosilicon compounds which may be used herein include, but are not limited to, 3,3′-bis(trimethoxysilylpropyl)disulfide, 3,3′-bis(triethoxysilylpropyl)disulfide, 3,3-bis(triethoxysilylpropyl)tetrasulfide, 3,3′-bis(triethoxysilylpropyl)octasulfide, 3,3′-bis(trimethoxysilylpropyl)tetrasulfide, 2,2′-bis(triethoxysilylethyl)tetrasulfide, 3,3′-bis(trimethoxysilylpropyl)triasulfide, 3,3′-bis(triethoxysilylpropyl)triasulfide, 3,3′-bis(tributoxysilylpropyl)disulfide, 3,3′-bis(trimethoxysilylpropyl)hexasufide, 3,3′-bis(trimethoxysilylpropyl)octasulfide, 3,3′-bis(trioctoxysilylpropyl)tetrasulfide, 3,3′-bis(trihexoxysilylpropyl)disulfide, 3,3′-bis(tri-2″-ethylhexoxysilylpropyl)trisulfide, 3,3′-bis(triisooctoxysilylpropyl)tetrasulfide, 3,3′-bis(tri-t-butoxysilyl-propyl)disulfide, 2,2′-bis(methoxydiethoxysilylethyl)tetrasulfide, 2,2′-bis(tripropoxysilylethyl)pentasulfide, 3,3′-bis(tricyclohexoxysilylpropyl)tetrasulfide, 3,3′-bis(tricyclopentoxysilylpropyl)trisulfide, 2,2′-bis(tri-2″-methyl-cyclohexoxysilylethyl)tetrasulfide, bis(trimethoxysilylmethyl)tetrasulfide, 3-methoxy ethoxy propoxysilyl 3′-diethoxybutoxy-silylpropyltetrasulfide, 2,2′-bis(dimethyl methoxysilylethyl)disulfide, 2,2′-bis(dimethyl sec.butoxysilylethyl)trisulfide, 3,3′-bis(methyl butylethoxysilylpropyl)tetrasulfide, 3,3′-bis(di t-butylmethoxysilylpropyl)tetrasulfide, 2,2′-bis(phenylmethylmethoxysilylethyl)trisulfide, 3,3′-bis(diphenyl isopropoxysilylpropyl)tetrasulfide, 3,3′-bis(diphenyl cyclohexoxysilylpropyl)disulfide, 3,3′-bis(dimethylethylmercaptosilylpropyl)tetrasulfide, 2,2′-bis(methyldimethoxysilylethyl)trisulfide, 2,2′-bis(methyl ethoxypropoxysilylethyl)tetrasulfide, 3,3′-bis(diethyl methoxysilylpropyl)tetrasulfide, 3,3′-bis(ethyl di-sec. butoxysilylpropyl)disulfide, 3,3′-bis(propyl diethoxysilylpropyl)disulfide, 3,3′-bis(butyl dimethoxysilylpropyl)trisulfide, 3,3′-bis(phenyl dimethoxysilylpropyl)tetrasulfide, 3-phenyl ethoxybutoxysilyl 3′-trimethoxysilyipropyl tetrasulfide, 4,4′-bis(trimethoxysilylbutyl)tetrasulfide, 6,6′-bis(triethoxysilylhexyl)tetrasulfide, 12,12′-bis(triisopropoxysilyl dodecyl)disulfide, 18,18′-bis(trimethoxysilyloctadecyl)tetrasulfide, 18,18′-bis(tripropoxysilyl-octadecenyl)tetrasulfide, 4,4′-bis(trimethoxysilylbutene-2-yl)tetrasulfide, 4,4′-bis(trimethoxysilylcyclohexylene)tetrasulfide, 5,5′-bis(dimethoxymethyl-silylpentyl)trisulfide, 3,3′-bis(trimethoxysilyl-2-methylpropyl)tetrasulfide, 3,3′-bis(dimethoxyphenylsilyl-2-methylpropyl)disulfide and the like. The preferred coupling agents are 3,3′-bis(triethoxysilylpropyl)disulfide and 3,3′-bis(triethoxysilylpropyl)tetrasulfide.

The polyalkylene oxides used herein have a weight average molecular weight of less than 200, preferably less than about 175 and most preferably less than about 150. Representative of these polyalkylene oxides include, but are not limited to, dimethylene glycol, diethylene glycol, dipropylene glycol, trimethylene glycol, triethylene glycol, tripropylene glycol, and the like and mixtures thereof. A preferred polyalkylene oxide for use herein is diethlyene glycol.

By employing the foregoing polyalkylene oxides herein in a cure-enhancing amount, the amount of coupling agent necessary to compound a silica filled rubber composition is advantageously reduced thereby providing an economical advantage. Accordingly, amounts of the coupling agent range from about 0.5 to about 10 phr, preferably from about 1 to about 8 phr and most preferably from about 1.5 to about 7 phr while the cure-enhancing amount of the polyalkylene oxide will ordinarily range from about 0.5 to about 10 preferably from about 1 to about 8 and most preferably from about 1.1 to about 5 phr. Such polyalkylene oxides, for example, may be premixed, or blended, with the coupling agents or added to the rubber mix during the rubber/silica/coupling agent processing, or mixing, stage.

The rubber compositions of this invention can be formulated in any conventional manner. Additionly, at least one other common additive can be added to the rubber compositions of this invention, if desired or necessary, in a suitable amount. Suitable common additives for use herein include vulcanizing agents, activators, retarders, antioxidants, plasticizing oils and softeners, fillers other than silica and carbon black, reinforcing pigments, antiozonants, waxes, tackifier resins, and the like and combinations thereof.

The rubber compositions of this invention are particularly useful when manufactured into articles such as, for example, tires, motor mounts, rubber bushings, power belts, printing rolls, rubber shoe heels and soles, rubber floor tiles, caster wheels, elastomer seals and gaskets, conveyor belt covers, hard rubber battery cases, automobile floor mats, mud flap for trucks, ball mill liners, windshield wiper blades and the like. Preferably, the rubber compositions of this invention are advantageously used in a tire as a component of any or all of the thermosetting rubber-containing portions of the tire. These include the tread, sidewall, and carcass portions intended for, but not exclusive to, a truck tire, passenger tire, off-road vehicle tire, vehicle tire, high speed tire, and motorcycle tire that also contain many different reinforcing layers therein. Such rubber or tire tread compositions in accordance with the invention may be used for the manufacture of tires or for the re-capping of worn tires.

### EXAMPLES

The following non-limiting examples are intended to further illustrate the present invention and are not intended to limit the scope of the invention in any manner.

### Examples 1-4 and Comparative Example A

Employing the ingredients indicated in Tables II and III (which are listed in parts per hundred of rubber by weight), several rubber compositions were compounded in the following manner: the ingredients indicated in Table II were added to an internal mixer and mixed until the materials are incorporated and thoroughly dispersed and discharged from the mixer. Discharge temperatures of about 160° C. are typical. The batch is cooled, and is reintroduced into the mixer along with the ingredients indicated in Table III. The second pass is shorter and discharge temperatures generally run between 93-105° C.

TABLE II
PHASE I

| Example or Comparative | | | | | |
|---|---|---|---|---|---|
| Example | 1 | 2 | 3 | 4 | A |
| SSBR 1216¹ | 75.00 | 75.00 | 75.00 | 75.00 | 75.00 |
| BR 1207² | 25.00 | 25.00 | 25.00 | 25.00 | 25.00 |
| N234³ | 5.00 | 5.00 | 5.00 | 5.00 | 5.00 |
| Zeosil 1165⁴ | 85.00 | 85.00 | 85.00 | 85.00 | 85.00 |
| Aromatic Oil | 44.00 | 44.00 | 44.00 | 44.00 | 44.00 |
| Naugard Q⁵ | 32.50 | 32.50 | 32.50 | 32.50 | 32.50 |
| Stearic Acid | 1.00 | 1.00 | 1.00 | 1.00 | 1.00 |
| Flexzone 7P⁶ | 1.00 | 1.00 | 1.00 | 1.00 | 1.00 |
| Sunproof Improved⁷ | 0.50 | 0.50 | 0.50 | 0.50 | 0.50 |
| Silquest A1289⁸ | 6.00 | 4.50 | 3.00 | 1.00 | 9.00 |
| Diethylene Glycol⁹ | 3.00 | 4.50 | 6.00 | 8.00 | 0.00 |
| MB-1:Total | 278.00 | 278.00 | 278.00 | 278.00 | 278.00 |

¹Solution styrene-butadiene rubber low bound styrene and medium vinyl content available from Goodyear.
²Polybutadiene rubber available from Goodyear.
³High surface area carbon black available from Cabot Corp.
⁴Highly dispersable silica available from Rhodia.
⁵TMQ, an antioxidant from Uniroyal Chemical.
⁶Paraphenylene diamine available from Uniroyal Chemical Company.
⁷Blend of hydrocarbon waxes available from Uniroyal Chemical Company.
⁸Tetrasulfide silane coupling agent available from OSI Specialty Chemicals.
⁹Diethylene Glycol possesses a weight average molecular weight of 106.

TABLE III
PHASE II

| Example or Comparative | | | | | |
|---|---|---|---|---|---|
| Example | 1 | 2 | 3 | 4 | A |
| MB-1¹⁰ | 278.00 | 278.00 | 278.00 | 278.00 | 278.00 |
| Zinc Oxide | 4.00 | 4.00 | 4.00 | 4.00 | 4.00 |
| Delac NS¹¹ | 1.50 | 1.50 | 1.50 | 1.50 | 1.50 |
| Sulfur 21-10¹² | 1.00 | 1.00 | 1.00 | 1.00 | 1.00 |
| Diphenyl guanidine | 2.00 | 2.00 | 2.00 | 2.00 | 2.00 |
| Total | 287.67 | 288.25 | 288.83 | 286.50 | 286.50 |

¹⁰MB-1 is the batch provided as set forth in TABLE II.
¹¹N-t-butyl-2-benzothiazole sulfenamide available from Uniroyal Chemical Company.
¹²Sulfur available from C.P. Hall.

Results

The compounded stocks prepared above were then sheeted out and cut for cure. The samples were cured for the times and at the temperatures indicated in Table IV and their physical properties evaluated. The results are summarized in Table IV below. Note that in Table IV, cure characteristics were determined using a Monsanto rheometer ODR 2000 (1° ARC, 100 cpm): MH is the maximum torque and ML is the minimum torque. Scorch safety (tₛ2) is the time to 2 units above minimum torque (ML), cure time (t₅₀) is the time to 50% of delta torque above minimum and cure time (t₉₀) is the time to 90% of delta torque above minimum. Tensile Strength, Elongation and Modulus were measured following procedures in ASTM D-412. Examples 1-4 illustrate a rubber composition within the scope of this invention. Comparative Example A represents a rubber composition outside the scope of this invention.

TABLE IV
CURED PHYSCIAL PROPERTIES

| Example or Comparative | | | | | |
|---|---|---|---|---|---|
| Example | 1 | 2 | 3 | 4 | A |

Cured Characteristics obtained at
160° C.

| | | | | | |
|---|---|---|---|---|---|
| ML (lb-in.) | 5.8 | 6.2 | 6.7 | 8.1 | 4.8 |
| MH (lb-in.) | 29.1 | 28.0 | 26.4 | 26.6 | 27.4 |
| Scorch safety t₅2 (min) | 1.9 | 1.5 | 1.7 | 1.6 | 2.8 |
| Cure time t₅₀ (min) | 4.8 | 4.0 | 3.3 | 3.0 | 6.2 |
| Cure time t₉₀ (min) | 12.4 | 10.4 | 8.5 | 7.3 | 15.5 |
| Cure time @ 160° C. | 14.0 | 12.0 | 10.5 | 9.0 | 17.5 |
| (min) | | | | | |

Physical Properties (Unaged)

| | | | | | |
|---|---|---|---|---|---|
| 100% Modulus (Mpa) | 2.16 | 2.23 | 1.98 | 1.63 | 2.16 |
| 300% Modulus (Mpa) | 7.55 | 7.76 | 6.27 | 4.24 | 8.27 |
| Tensile Strength (Mpa) | 19.59 | 19.68 | 19.09 | 17.98 | 19.43 |
| Elongation, % at Break | 597.00 | 597.00 | 686.00 | 856.00 | 547.00 |
| Hardness, Shore A | 64.00 | 65.00 | 68.00 | 68.00 | 62.00 |

Mooney Scorch (MS at 132° C.)

| | | | | | |
|---|---|---|---|---|---|
| 3 Pt. Rise Time (min) | 12.6 | 9.5 | 7.7 | 7.0 | 19.9 |
| 18 Pt. Rise Time (min) | 18.4 | 14.2 | 11.2 | 10.3 | 27.4 |

Moonev Viscosity (ML₄ at 100° C.)

| | | | | | |
|---|---|---|---|---|---|
| ML₄ | 84.4 | 92.3 | 97.2 | 126.6 | 74.6 |

TABLE IV

| Example or Comparative | | | | | |
|---|---|---|---|---|---|
| Example | 1 | 2 | 3 | 4 | A |

Tangent Delta 60° C. (10 Hz) [RPA-
2000] % Strain

| | | | | | |
|---|---|---|---|---|---|
| 0.7 | 0.075 | 0.063 | 0.073 | 0.065 | 0.088 |
| 1.0 | 0.084 | 0.074 | 0.068 | 0.071 | 0.103 |
| 2.0 | 0.102 | 0.094 | 0.097 | 0.097 | 0.135 |
| 5.0 | 0.138 | 0.138 | 0.155 | 0.153 | 0.177 |
| 7.0 | 0.153 | 0.148 | 0.163 | 0.171 | 0.176 |
| 14.0 | 0.196 | 0.191 | 0.203 | 0.233 | 0.202 |

Tangent Delta 60° C. (10 Hz)
[MTS Tester]
% strain

| | | | | | |
|---|---|---|---|---|---|
| 4.0 | 0.175 | 0.165 | 0.160 | 0.177 | 0.214 |
| 10.0 | 0.173 | 0.180 | 0.178 | 0.199 | 0.209 |

It can be seen from the above data that the examples within the scope of this invention (Examples 1-4) containing a polyalkylene oxide having a weight average molecular weight less than 200 provide superior performance when compared to the example containing only a coupling agent (Comparative Example A). The tangent delta value for Example 1 was significantly lower than that of Comparative Example A.

The tangent delta values for Examples 2-4 were also significantly lower compared to that of Comparative Example A. Additionally, the cure rate of Examples 1-4 was significantly faster as compared to that of Comparative Example A. Thus, by adding a polyalkylene oxide as disclosed herein to the rubber composition such that the lower amounts of the coupling agent can thus be employed, the cure rate is increased while the tangent delta value of the rubber composition has been significantly improved without any sacrifice in physical properties resulting in an economical cost advantage being realized.

### Examples 5-8 and Comparative Example B

Employing the ingredients indicated in Tables V and VI (which are listed in parts per hundred of rubber by weight), several rubber compositions were compounded in the following manner: the ingredients indicated in Table V were added to an internal mixer and mixed until the materials are incorporated and thoroughly dispersed and discharged from the mixer. Discharge temperatures of about 160° C. are typical. The batch is cooled, and is reintroduced into the mixer along with the ingredients indicated in Table VI. The second pass is shorter and discharge temperatures generally run between 93-105° C.

TABLE V
PHASE I

| Example or Comparative | | | | | |
|---|---|---|---|---|---|
| Example | 5 | 6 | 7 | 8 | B |
| SSBR 1216 | 75.00 | 75.00 | 75.00 | 75.00 | 75.00 |
| BR 1207 | 25.00 | 25.00 | 25.00 | 25.00 | 25.00 |
| N234 | 32.00 | 32.00 | 32.00 | 32.00 | 32.00 |
| Zeosil 1165 | 44.00 | 44.00 | 44.00 | 44.00 | 44.00 |
| Sundex 8125¹³ | 40.00 | 40.00 | 40.00 | 40.00 | 40.00 |
| Stearic Acid | 1.00 | 1.00 | 1.00 | 1.00 | 1.00 |
| Flexzone 7P | 2.00 | 2.00 | 2.00 | 2.00 | 2.00 |
| Sunproof Improved | 1.50 | 1.50 | 1.50 | 1.50 | 1.50 |
| Silquest A1289 | 2.46 | 1.76 | 2.46 | 2.46 | 3.52 |
| Diethylene Glycol | 1.47 | 2.45 | 1.47 | 0.00 | 0.00 |
| (70% Active)¹⁴ | | | | | |
| MB-2:Total | 224.43 | 224.71 | 224.43 | 222.96 | 224.02 |

¹³Aromatic oil available from Sun Oil.
¹⁴Diethylene Glycol possesses a weight average molecular weight of 106.

TABLE VI
PHASE II

| Example or Comparative | | | | | |
|---|---|---|---|---|---|
| Example | 5 | 6 | 7 | 8 | B |
| MB-2¹⁵ | 224.43 | 224.71 | 224.43 | 222.96 | 224.02 |
| Diethylene Glycol | 0.00 | 0.00 | 0.00 | 1.47 | 0.00 |
| (70% Active)¹⁶ | | | | | |
| Zinc Oxide | 2.50 | 2.50 | 2.50 | 2.50 | 2.50 |
| Delac NS | 1.50 | 1.50 | 1.50 | 1.50 | 1.50 |
| Sulfur 21-10 | 2.00 | 2.00 | 2.00 | 2.00 | 2.00 |
| Diphenyl guanidine | 1.00 | 1.00 | 1.00 | 1.00 | 1.00 |
| Total | 231.02 | 231.43 | 231.71 | 231.43 | 231.43 |

¹⁵MB-2 is the batch provided as set forth in TABLE V.
¹⁶Diethylene Glycol possesses a weight average molecular weight of 106.

Results

The compounded stocks prepared above were then sheeted out and cut for cure. The samples were cured for the times and at the temperatures indicated in Table VII and their physical properties evaluated. The results are summarized in Table VII below. Note that in Table VII, cure characteristics were determined as described above. Tensile Strength, Elongation and Modulus were measured following procedures in ASTM D-412. Examples 5-8 illustrate a rubber composition within the scope of this invention. Comparative Example B represents a rubber composition outside the scope of this invention.

TABLE VII
CURED PHYSICAL PROPERTIES

| Example or Comparative | | | | | |
|---|---|---|---|---|---|
| Example | 5 | 6 | 7 | 8 | B |

Cured Characteristics obtained at
160° c

| | | | | | |
|---|---|---|---|---|---|
| ML (lb-in.) | 9.99 | 10.72 | 10.62 | 9.63 | 9.22 |
| MH (lb-in.) | 41.38 | 41.45 | 42.61 | 40.69 | 37.98 |
| Scorch safety t₅2 (min) | 3.39 | 3.22 | 3.41 | 3.37 | 3.69 |
| Cure time t₅₀ (min) | 5.89 | 5.39 | 5.94 | 5.73 | 6.47 |
| Cure time t₉₀ (min) | 15.45 | 12.78 | 16.59 | 13.81 | 18.74 |

Mooney Scorch CMS at 135° C.)

| | | | | | |
|---|---|---|---|---|---|
| 3 Pt. Rise Time (min) | 13.00 | 11.00 | 13.00 | 12.00 | 14.00 |

Mooney Viscosity(ML at 100° C.)

| | | | | | |
|---|---|---|---|---|---|
| ML₄ | 78.00 | 77.00 | 78.00 | 72.00 | 75.00 |
| Cure time @ 160° C. (min) | 17.5 | 15.0 | 18.5 | 16.0 | 21.0 |

Tangent Delta 60° C. (10 Hz)
% Strain

| | | | | | |
|---|---|---|---|---|---|
| 0.7 | 0.118 | 0.103 | 0.110 | 0.101 | 0.108 |
| 1.0 | 0.123 | 0.120 | 0.126 | 0.127 | 0.118 |
| 2.0 | 0.163 | 0.170 | 0.156 | 0.167 | 0.161 |
| 5.0 | 0.204 | 0.207 | 0.203 | 0.204 | 0.201 |
| 7.0 | 0.201 | 0.207 | 0.205 | 0.207 | 0.202 |
| 14.0 | 0.208 | 0.210 | 0.209 | 0.204 | 0.201 |

Dvnamic Modulus ((G)KPa))
% Strain

| | | | | | |
|---|---|---|---|---|---|
| 0.7 | 6044 | 6113 | 5960 | 5807 | 4896 |
| 1 | 5497 | 5618 | 5470 | 5181 | 4634 |
| 2 | 4437 | 4333 | 4331 | 4099 | 3618 |
| 5 | 3001 | 2974 | 2999 | 2879 | 2482 |
| 7 | 2609 | 2601 | 2633 | 2441 | 2230 |
| 14 | 1973 | 1923 | 1923 | 1870 | 1723 |

It can be seen from the above data that the examples within the scope of this invention (Examples 5-8) containing a polyalkylene oxide wherein the amount of silica to carbon black was relatively equal on a volume ratio provide equivalent to slightly improved performance when compared to the example outside the scope of this invention (Comparative Example B) containing only a coupling agent.

The cure rate of Examples 5-8 was significantly faster as compared to that of Comparative Example B without any sacrifice in physical properties of the rubber component, e.g., mooney scorch value and tangent delta value. Also, the tangent delta values for Examples 5-8 were lower or relatively equivalent compared to that of Comparative Example B. Thus, by adding a polyalkylene oxide to the rubber composition such that the lower amounts of the coupling agent can be employed, the cure rate is increased while the tangent delta value of the rubber composition has been improved or maintained without any sacrifice in physical properties resulting in an economical cost advantage being realized.

### Comparative Examples C and D

Employing the ingredients indicated in Tables VIII and IX (which are listed in parts per hundred of rubber by weight), several rubber compositions were compounded in the following manner: the ingredients indicated in Table VIII were added to an internal mixer and mixed until the materials are incorporated and thoroughly dispersed and discharged from the mixer. Discharge temperatures of about 160° C. are typical. The batch is cooled, and is reintroduced into the mixer along with the ingredients indicated in Table IX. The second pass is shorter and discharge temperatures generally run between 93-105° C.

TABLE VIII
PHASE I

| Comparative Example | C | D |
|---|---|---|
| SSBR 1216 | 75.00 | 75.00 |
| BR 1207 | 25.00 | 25.00 |
| N234 | 5.00 | 5.00 |
| Zeosil 1165 | 80.00 | 80.00 |
| Sundex 81251 | 44.00 | 44.00 |
| Naugard Q | 1.00 | 1.00 |
| Stearic Acid | 1.00 | 1.00 |
| Flexzone 7P | 1.00 | 1.00 |
| Sunproof Improved | 0.50 | 0.50 |
| Silquest A1289 | 8.00 | 4.00 |
| Carbomax 3350¹⁷ | 0.00 | 4.00 |
| MB-3:Total | 240.50 | 240.50 |

¹⁷Carbomax 3350 is a polyethylene glycol possessing a weight average molecular weight of 3000-3700 and is available from Harwick Standard Distribution Corp. (Akron, Ohio)

TABLE IX
PHASE II

| Comparative Example | C | D |
|---|---|---|
| MB-3¹⁸ | 240.50 | 240.50 |
| Zinc Oxide | 4.00 | 4.00 |
| Delac NS | 1.50 | 1.50 |
| Sulfur | 1.50 | 1.50 |
| Diphenyl guanidine | 2.00 | 2.00 |
| Total | 249.50 | 249.50 |

¹⁸MB-3 is the batch provided as set forth in TABLE VIII.

Results

The compounded stocks prepared above were then sheeted out and cut for cure. The samples were cured for the times and at the temperatures indicated in Table X and their physical properties evaluated. The results are summarized in Table X below. Note that in Table X, cure characteristics were determined as described above. Tensile Strength, Elongation and Modulus were again measured following procedures in ASTM D-412.

TABLE X
CURED PHYSICAL PROPERTIES

| Comparative Example | C | D |
|---|---|---|
| Cured Characteristics obtained at 160° C. | | |
| ML (lb-in.) | 9.63 | 16.41 |
| MH (lb-in.) | 48.38 | 54.02 |
| Scorch safety t₅2 (min) | 2.21 | 2.47 |
| Cure time t₅₀ (min) | 4.40 | 4.39 |
| Cure time t₉₀ (min) | 14.93 | 14.50 |
| Cure time at 170° C. (min) | 20.0 | 20.0 |
| Physical Properties | | |
| 100% Modulus (Mpa) | 3.30 | 2.60 |
| 300% Modulus (Mpa) | 12.60 | 9.40 |
| Tensile Strength (Mpa) | 18.50 | 19.30 |
| Elongation, % at Break | 400.00 | 530.00 |
| Hardness, Shore A | 70.00 | 68.00 |
| Cured at 170° C. (min) | 20.00 | 20.00 |
| Tanaent Delta 60° C. (10 Hz) % Strain | | |
| 0.7 | 0.073 | 0.055 |
| 1.0 | 0.088 | 0.063 |
| 2.0 | 0.109 | 0.086 |
| 5.0 | 0.152 | 0.151 |
| 7.0 | 0.179 | 0.183 |
| 14.0 | 0.200 | 0.215 |
| Dynamic Modulus ((G′)KPa)) % Strain | | |
| 0.7 | 7804 | 8232 |
| 1 | 7427 | 7951 |
| 2 | 6380 | 6984 |
| 5 | 4721 | 5020 |
| 7 | 3839 | 4062 |
| 14 | 2603 | 2553 |
| Din Abrasion | | |
| Relative Volume Loss (mm³) | 94.4 | 97.6 |
| Abrasion Resistance Index | 129.8 | 125.6 |

As the above data show, by employing a polyalkylene oxide having a weight average molecular weight greater than 200 in a rubber composition (Comparative Example D) provides relatively equal to worse performance when compared to the example containing only a coupling agent (Comparative Example C). The tangent delta value for Comparative Example D was relatively equal to that of Comparative Example C. Additionally, the cure rate of Comparative Example D was relatively equal as compared to that of Comparative Example C. Thus, a polyalkylene oxide having a weight average molecular weight greater than 200 in a rubber composition provided no advantage compared to that of a rubber composition containing a coupling agent, alone.

Although the invention has been described in its preferred form with a certain degree of particularity, obviously many changes and variations are possible therein and will be apparent to those skilled in the art after reading the foregoing description. It is therefore to be understood that the present invention may be presented otherwise than as specifically described herein without departing from the spirit and scope thereof.

What is claimed is:

1. A rubber composition comprising (a) a rubber component; (b) a silica filler; (c) a coupling agent; and (d) a cure-enhancing amount of a polyalkylene oxide having a weight average molecular weight less than 200.

2. The rubber composition of claim 1 wherein the rubber component is selected from the group consisting of natural rubber, homopolymers of conjugated diolefins, copolymers of conjugated diolefins and ethylenically unsaturated monomers and mixtures thereof.

3. The rubber composition of claim 1 wherein the rubber component is selected from the group consisting of natural rubber, cis-polyisoprene, polybutadiene, poly(styrene-butadiene), styrene-isoprene copolymers, isoprene-butadiene copolymers, styrene-isoprene-butadiene tripolymers, polychloroprene, chloro-isobutene-isoprene, nitrile-chloroprene, styrene-chloroprene, poly (acrylonitrile-butadiene), ethylene-propylene-diene terpolymer and combinations thereof.

4. The rubber composition of claim 1 wherein the silica filler is selected from the group consisting of silica, precipitated silica, amorphous silica, vitreous silica, fumed silica, fused silica, synthetic silicate, alkaline earth metal silicate, highly dispersed silicate and mixtures thereof.

5. The rubber composition of claim 1 wherein the coupling agent is a sulfur-containing coupling agent.

6. The rubber composition of claim 5 wherein the sulfur-containing coupling agent is of the general formula:
Z—R¹—Sₙ—R²—Z
in which Z is selected from the group consisting of 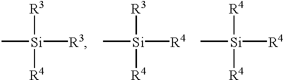
wherein R³ is an alkyl group of from 1 to 4 carbon atoms, cyclohexyl or phenyl; and R⁴ is an alkoxy of from 1 to 8 carbon atoms, or cycloalkoxy of 5 to 8 carbon atoms; and R¹ and R² are independently a divalent hydrocarbon of from 1 to 18 carbon atoms and n is an integer of from about 2 to about 8.

7. The rubber composition of claim 6 wherein the sulfur-containing coupling agent is selected from the group consisting of 3,3′-bis(trimethoxysilylpropyl)disulfide, 3,3′-bis(triethoxysilylpropyl)disulfide, 3,3-bis(triethoxysilylpropyl)tetrasulfide, 3,3′-bis(triethoxysilylpropyl)octasulfide, 3,3′-bis(trimethoxysilylpropyl)tetrasulfide, 2,2′-bis(triethoxysilylethyl)tetrasulfide, 3,3′-bis(trimethoxysilylpropyl)triasulfide, 3,3′-bis(triethoxysilylpropyl)triasulfide, 3,3′-bis(tributoxysilylpropyl)disulfide, 3,3′-bis(trimethoxysilylpropyl)hexasufide, 3,3′-bis(trimethoxysilylpropyl)octasulfide, 3,3′-bis(trioctoxysilylpropyl)tetrasulfide, 3,3′-bis(trihexoxysilylpropyl)disulfide, 3,3′-bis(tri-2″-ethylhexoxysilylpropyl)trisulfide, 3,3′-bis(triisooctoxysilylpropyl)tetrasulfide, 3,3′-bis(tri-t-butoxysilylpropyl)disulfide, 2,2′-bis(methoxydiethoxysilylethyl)tetrasulfide, 2,2′-bis(tripropoxysilylethyl)pentasulfide, 3,3′-bis(tricyclohexoxysilylpropyl)tetrasulfide, 3,3′-bis(tricyclopentoxysilylpropyl)trisulfide, 2,2′-bis(tri-2″-methylcyclohexoxysilylethyl)tetrasulfide, bis(trimethoxysilylmethyl)tetrasulfide, 3-methoxyethoxypropoxysilyl 3′-diethoxybutoxy-silylpropyltetrasulfide, 2,2′-bis(dimethylmethoxysilylethyl)disulfide, 2,2′-bis(dimethylsec.butoxysilylethyl)trisulfide, 3,3′-bis(methyl butylethoxysilylpropyl)tetrasulfide, 3,3′-bis(dit-butylmethoxysilylpropyl)tetrasulfide, 2,2′-bis(phenylmethylmethoxysilylethyl)trisulfide, 3,3′-bis(diphenyl isopropoxysilylpropyl)tetrasulfide, 3,3′-bis(diphenylcyclohexoxysilylpropyl)disulfide, 3,3′-bis(dimethylethylmercaptosilylpropyl)tetrasulfide, 2,2′-bis(methyldimethoxysilylethyl)trisulfide, 2,2′-bis(methylethoxypropoxysilylethyl)tetrasulfide, 3,3′-bis(diethylmethoxysilylpropyl)tetrasulfide, 3,3′-bis(ethyl di-sec. butoxysilylpropyl)disulfide, 3,3′-bis(propyldiethoxysilylpropyl)disulfide, 3,3′-bis(butyldimethoxysilylpropyl)trisulfide, 3,3′-bis(phenyldimethoxysilylpropyl)tetrasulfide, 3-phenylethoxybutoxysilyl 3′-trimethoxysilylpropyltetrasulfide, 4,4′-bis(trimethoxysilylbutyl)tetrasulfide, 6,6′-bis(triethoxysilylhexyl)tetrasulfide, 12,12′-bis(triisopropoxysilyl dodecyl)disulfide, 18,18′-bis(trimethoxysilyloctadecyl)tetrasulfide, 18,18′-bis(tripropoxysilyloctadecenyl)tetrasulfide, 4,4′-bis(trimethoxysilyl-butene-2-yl)tetrasulfide, 4,4′-bis(trimethoxysilylcyclohexylene)tetrasulfide, 5,5′-bis(dimethoxymethylsilylpentyl)trisulfide, 3,3′-bis(trimethoxysilyl-2-methylpropyl)tetrasulfide, 3,3′-bis(dimethoxyphenylsilyl-2-methylpropyl)disulfide and combinations thereof.

8. The rubber composition of claim 1 wherein the polyalkylene oxide is selected from the group consisting of dimethylene glycol, diethylene glycol, dipropylene glycol, trimethylene glycol, triethylene glycol, tripropylene glycol and combinations thereof.

9. The rubber composition of claim 1 wherein the polyalkylene oxide is diethylene glycol.

10. The rubber composition of claim 7 wherein the polyalkylene oxide is diethylene glycol.

11. The rubber composition of claim 1 wherein the silica filler is present in an amount of from about 15 to about 100 phr, the coupling agent is present in an amount of from about 1 to about 8 phr and the polyalkylene oxide is present in an amount of from about 1 to about 8 phr.

12. The rubber composition of claim 10 wherein the silica filler is present in an amount of from about 15 to about 100 phr, the sulfur-containing coupling agent is present in an amount from about 1 to about 8 phr and diethylene glycol is present in an amount of from about 1 to about 8 phr.

13. The rubber composition of claim 1 which is a tire tread, motor mount, rubber bushing, power belt, printing roll, rubber shoe heel and sole, rubber floor tile, caster wheel, elastomer seal and gasket, conveyor belt cover, hard rubber battery case, automobile floor mat, truck mud flap, ball mill liner or windshield wiper blade.

14. The rubber composition of claim 1 further comprising at least one other additive selected from the group consisting of vulcanizing agents, activators, fillers other than silica, retarders, antioxidants, plasticizing oils, and softeners, reinforcing pigments, antiozonants, waxes, tackifier resins and combinations thereof.

15. The rubber composition of claim 1 wherein the tangent delta value of the rubber composition is lower than that of a similar rubber composition in which a significant amount up to the entire amount of the polyalkylene oxide is not present in the rubber composition.

16. A method for decreasing the tangent delta value of a rubber composition which comprises the step of forming a rubber composition comprising (a) a rubber component; (b) a silica filler; (c) a coupling agent; and (d) a polyalkylene oxide having a weight average molecular weight of less than 200.

17. The method of claim 16 wherein the rubber component is selected from the group consisting of natural rubber, homopolymers of conjugated diolefins, copolymers of conjugated diolefins and ethylenically unsaturated monomers and mixtures thereof.

18. The method of claim 16 wherein the silica filler is selected from the group consisting of silica, precipitated silica, amorphous silica, vitreous silica, fumed silica, fused silica, synthetic silicate, alkaline earth metal silicate, highly dispersed silicate and mixtures thereof.

19. The method of claim 16 wherein the coupling agent is a sulfur-containing coupling agent of the general formula:
Z—R¹—Sₙ—R²—Z
in which Z is selected from the group consisting of 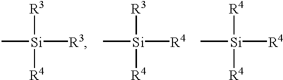
wherein R³ is an alkyl group of from 1 to 4 carbon atoms, cyclohexyl or phenyl; and R⁴ is an alkoxy of from 1 to 8 carbon atoms, or cycloalkoxy of 5 to 8 carbon atoms; and R¹ and R² are independently a divalent hydrocarbon of from 1 to 18 carbon atoms and n is an integer of from about 2 to about 8.

20. The method of claim 19 wherein the sulfur-containing coupling agent is selected from the group consisting of 3,3′-bis(trimethoxysilylpropyl)disulfide, 3,3′-bis(triethoxysilylpropyl)disulfide, 3,3-bis(triethoxysilylpropyl)tetrasulfide, 3,3′-bis(triethoxysilylpropyl)octasulfide, 3,3′-bis(trimethoxysilylpropyl)tetrasulfide, 2,2′-bis(triethoxysilylethyl)tetrasulfide, 3,3′-bis(trimethoxysilylpropyl)triasulfide, 3,3′-bis(triethoxysilylpropyl)triasulfide, 3,3′-bis(tributoxysilylpropyl)disulfide, 3,3′-bis(trimethoxysilylpropyl)hexasufide, 3,3′-bis(trimethoxysilylpropyl)octasulfide, 3,3′-bis(trioctoxysilylpropyl)tetrasulfide, 3,3′-bis(trihexoxysilylpropyl)disulfide, 3,3′-bis(tri-2″-ethylhexoxysilylpropyl)trisulfide, 3,3′-bis(triisooctoxysilyipropyl)tetrasulfide, 3,3′-bis(tri-t-butoxysilylpropyl)disulfide, 2,2′-bis(methoxydiethoxysilylethyl)tetrasulfide, 2,2′-bis(tripropoxysilylethyl)pentasulfide, 3,3′-bis(tricyclohexoxysilylpropyl)tetrasulfide, 3,3′-bis(tricyclopentoxysilylpropyl)trisulfide, 2,2′-bis(tri-2″-methylcyclohexoxysilylethyl)tetrasulfide, bis(trimethoxysilylmethyl)tetrasulfide, 3-methoxy ethoxy propoxysilyl 3′-diethoxybutoxy-silylpropyltetrasulfide, 2,2′-bis(dimethylmethoxysilylethyl)disulfide, 2,2′-bis(dimethylsec.butoxysilylethyl)trisulfide, 3,3′-bis(methyl butylethoxysilylpropyl)tetrasulfide, 3,3′-bis(di t-butylmethoxysilylpropyl)tetrasulfide, 2,2′-bis(phenylmethylmethoxysilylethyl)trisulfide, 3,3′-bis(diphenyl isopropoxysilylpropyl)tetrasulfide, 3,3′-bis(diphenylcyclohexoxysilylpropyl)disulfide, 3,3′-bis(dimethylethylmercaptosilylpropyl)tetrasulfide, 2,2′-bis(methyldimethoxysilylethyl)trisulfide, 2,2′-bis(methylethoxypropoxysilylethyl)tetrasulfide, 3,3′-bis(diethylmethoxysilylpropyl)tetrasulfide, 3,3′-bis(ethyldi-sec.butoxysilylpropyl)disulfide, 3,3′-bis(propyldiethoxysilylpropyl)disulfide, 3,3′-bis(butyldimethoxysilylpropyl)trisulfide, 3,3′-bis(phenyldimethoxysilylpropyl)tetrasulfide, 3-phenylethoxybutoxysilyl 3′-trimethoxysilylpropyl tetrasulfide, 4,4′-bis(trimethoxysilylbutyl)tetrasulfide, 6,6′-bis(triethoxysilylhexyl)tetrasulfide, 12,12′-bis(triisopropoxysilyldodecyl)disulfide, 18,18′-bis(trimethoxysilyloctadecyl)tetrasulfide, 18,18′-bis(tripropoxysilyloctadecenyl)tetrasulfide, 4,4′-bis(trimethoxysilyl-butene-2-yl)tetrasulfide, 4,4′-bis(trimethoxysilylcyclohexylene)tetrasulfide, 5,5′-bis(dimethoxymethylsilylpentyl)trisulfide, 3,3′-bis(trimethoxysilyl-2-methylpropyl)tetrasulfide, 3,3′-bis(dimethoxyphenylsilyl-2-methylpropyl)disulfide and combinations thereof.

21. The method of claim 16 wherein the polyalkylene oxide is selected from the group consisting of dimethylene glycol, diethylene glycol, dipropylene glycol, trimethylene glycol, triethylene glycol, tripropylene glycol and combinations thereof.

22. The method of claim 19 wherein the polyalkylene oxide is diethylene glycol.

23. The method of claim 16 wherein the silica filler is present in an amount of from about 15 to about 100 phr, the coupling agent is present in an amount of from about 1 to about 8 phr and the polyalkylene oxide is present in an amount of from about 1 to about 8 phr.

24. The method of claim 22 wherein the silica filler is present in an amount of from about 15 to about 100 phr, the sulfur-containing coupling agent is present in an amount from about 1 to about 8 phr and diethylene glycol is present in an amount of from about 1 to about 8 phr.

25. In a rubber composition comprising (a) a rubber component; (b) a silica filler; and (c) a coupling agent, wherein the improvement comprises the presence of a cure-enhancing amount of at least one polyalkylene oxide having a weight average molecular weight of less than 200.

26. In the rubber composition of claim 25 wherein the coupling agent is a sulfur-containing coupling agent of the general formula:
Z—R¹—Sₙ—R²—Z
in which Z is selected from the group consisting of 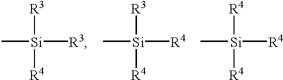
wherein R³ is an alkyl group of from 1 to 4 carbon atoms, cyclohexyl or phenyl; and R⁴ is an alkoxy of from 1 to 8 carbon atoms, or cycloalkoxy of 5 to 8 carbon atoms; and R¹ and R² are independently a divalent hydrocarbon of from 1 to 18 carbon atoms and n is an integer of from about 2 to about 8.

27. In the rubber composition of claim 26 wherein the sulfur-containing coupling agent is selected from the group consisting of 3,3′-bis(trimethoxysilylpropyl)disulfide, 3,3′-bis(triethoxysilylpropyl)disulfide, 3,3-bis(triethoxysilylpropyl)tetrasulfide, 3,3′-bis(triethoxysilylpropyl)octasulfide, 3,3′-bis(trimethoxysilylpropyl)tetrasulfide, 2,2′-bis(triethoxysilylethyl)tetrasulfide, 3,3′-bis(trimethoxysilylpropyl)triasulfide, 3,3′-bis(triethoxysilylpropyl)triasulfide, 3,3′-bis(tributoxysilylpropyl)disulfide, 3,3′-bis(trimethoxysilylpropyl)hexasufide, 3,3′-bis(trimethoxysilylpropyl)octasulfide, 3,3′-bis(trioctoxysilylpropyl)tetrasulfide, 3,3′-bis(trihexoxysilylpropyl)disulfide, 3,3′-bis(tri-2″-ethylhexoxysilylpropyl)trisulfide, 3,3′-bis(triisooctoxysilyipropyl)tetrasulfide, 3,3′-bis(tri-t-butoxysilylpropyl)disulfide, 2,2′-bis(methoxydiethoxysilylethyl)tetrasulfide, 2,2′-bis(tripropoxysilylethyl)pentasulfide, 3,3′-bis(tricyclohexoxysilylpropyl)tetrasulfide, 3,3′-bis(tricyclopentoxysilylpropyl)trisulfide, 2,2′-bis(tri-2″-methylcyclohexoxysilylethyl)tetrasulfide, bis(trimethoxysilylmethyl)tetrasulfide, 3-methoxyethoxypropoxysilyl 3′-diethoxybutoxy-silylpropyltetrasulfide, 2,2′-bis(dimethyl methoxysilylethyl)disulfide, 2,2′-bis(dimethyl sec.butoxysilylethyl)trisulfide, 3,3′-bis(methyl butylethoxysilylpropyl)tetrasulfide, 3,3′-bis(di t-butylmethoxysilylpropyl)tetrasulfide, 2,2′-bis(phenyl methyl methoxysilylethyl)trisulfide, 3,3′-bis(diphenyl isopropoxysilylpropyl)tetrasulfide, 3,3′-bis(diphenylcyclohexoxysilylpropyl)disulfide, 3,3′-bis(dimethylethylmercaptosilylpropyl)tetrasulfide, 2,2′-bis(methyl dimethoxysilylethyl)trisulfide, 2,2′-bis(methylethoxypropoxysilylethyl)tetrasulfide, 3,3′-bis(diethylmethoxysilylpropyl)tetrasulfide, 3,3′-bis(ethyl di-sec.butoxysilylpropyl)disulfide, 3,3′-bis(propyldiethoxysilylpropyl)disulfide, 3,3′-bis(butyldimethoxysilylpropyl)trisulfide, 3,3′-bis(phenyl dimethoxysilylpropyl)tetrasulfide, 3-phenylethoxybutoxysilyl 3′-trimethoxysilylpropyl tetrasulfide, 4,4′-bis(trimethoxysilylbutyl)tetrasulfide, 6,6′-bis(triethoxysilylhexyl)tetrasulfide, 12,12′-bis(triisopropoxysilyl dodecyl)disulfide, 18,18′-bis(trimethoxysilyloctadecyl)tetrasulfide, 18,18′-bis(tripropoxysilyloctadecenyl)tetrasulfide, 4,4′-bis(trimethoxysilyl-buten-2-yl)tetrasulfide, 4,4′-bis(trimethoxysilylcyclohexylene)tetrasulfide, 5,5′-bis(dimethoxymethylsilylpentyl)trisulfide, 3,3′-bis(trimethoxysilyl-2-methylpropyl)tetrasulfide, 3,3′-bis(dimethoxyphenylsilyl-2-methylpropyl)disulfide and combinations thereof.

28. In the rubber composition of claim 25 wherein the polyalkylene oxide is selected from the group consisting of dimethylene glycol, diethylene glycol, dipropylene glycol, trimethylene glycol, triethylene glycol, tripropylene glycol and combinations thereof.

29. In the rubber composition of claim 25 wherein the polyalkylene oxide is diethylene glycol.

30. In the rubber composition of claim 25 wherein the coupling agent is present in an amount of from about 1 to about 8 phr and the polyalkylene oxide is present in an amount of from about 1 to about 8 phr.

31. In the rubber composition of claim 29 wherein the sulfur-containing coupling agent is present in an amount from about 1 to about 8 phr and diethylene glycol is present in an amount of from about 1 to about 8 phr.
